(19) United States
(12) Patent Application Publication
(10) Pub. No.: US 2015/0312715 A1
(43) Pub. Date: Oct. 29, 2015

(54) ARRANGEMENT AND METHOD FOR LOCATION BASED CONTENT PROVISION

(71) Applicant: Lapdoog Oy, Helsinki (FI)

(72) Inventors: Jouni HAAVISTO, Vantaa (FI); Kimmo NARKILAHTI, Helsinki (FI)

(73) Assignee: Lapdoog Oy, Helsinki (FI)

(21) Appl. No.: 14/259,430

(22) Filed: Apr. 23, 2014

(51) Int. Cl. H04W 4/02

(52) U.S. Cl. CPC H04W 4/021

(57) ABSTRACT

Electronic arrangement including a network accessible service display entity for enabling a user to obtain information regarding an asset associated with physical location via service display accessible with a terminal device, a location management entity configured to obtain an indication of a physical location of the user, a zone database configured to store a plurality of geographical content provision zones for the asset relating to the physical location of the asset, and a content provision entity configured to provide content to a user visiting the service display based on the particular zone whereto the user location is mapped. Related method and computer program product are presented.

### FIELD OF THE INVENTION

Generally the present invention pertains to computer and communication systems. In particular, the present invention concerns arrangements and methods for location based provision of digital content.

### BACKGROUND

In the prevailing time of information flood, there is an ever-growing need for practical solutions allowing targeted content provision. Businesses are desperate to find feasible ways to attract consumers, which has led to the current situation; consumers are being drowned in advertisement and information spam. Computing and communications devices allow ways to reach consumers more conveniently and in a larger scale. However, such means may ultimately appear intrusive and thereby the end result of trying to attract customers may be disappointing, potentially the exact opposite.

By the increasing number of mobile computing devices such as smartphones and tablets comprising user locating means, location-based services (LBS) has become a trend topic. Since physical location plays an important role in consumer behavior and interest, related services are being developed. Today a consumer may easily locate location-associated services such as stores and restaurants by GPS (Global Positioning System) mapping software applications. However, such software applications tend to lack any targeted information and all users will be provided with the same set of basic information.

Web pages on the other hand are one of the most, if not the most, popular source of consumer information today. Web pages represent a primary marketing channel for businesses to provide real time information such as changes in opening hours, offers, reservation systems, etc. Depending e.g. on the distance to a service provider's physical location, consumers will share various interests towards it. Someone close by may be interested more in ongoing offers whereas consumers located further away may find it more beneficial to get information on upcoming events. Nowadays, web pages tend to provide the same information for every visitor and personalization, if any, is based on at least partially user-defined account settings or click-through advertisement banners provided by an additional ad service.

### SUMMARY

The objective is to at least alleviate one or more problems described hereinabove not yet satisfactorily solved by the known arrangements, and to provide a feasible solution for location based content provision especially through approaching online users with targeted information.

The aforesaid objective is achieved by the embodiments of an arrangement and method in accordance with the present invention. The present solution may be applied for obtaining an indication of the location of a user visiting an asset's online service display, such as a web page or web site, and thereby providing targeted information to the user.

In one aspect of the present invention, an electronic arrangement, such as one or more servers, comprises
a network accessible service display entity for enabling a user to obtain information regarding an asset associated with physical location via service display, optionally including a web page, accessible with a terminal device,
a location management entity configured to obtain an indication of a physical location of the user,
a zone database configured to store a plurality of geographical content provision zones for the asset relating to the physical location of the asset, and
a content provision entity configured to provide content to a user visiting said network accessible service display based on the particular zone whereto the user location is mapped.

In one embodiment the network accessible service display entity provides and/or controls at least portion of Internet-accessible service display such as a web page. Alternatively it may provide/control a plurality of web pages forming a web site.

A web page or web site may be hosted by a number of web servers. Preferably, a user may access a web page through a web browser application.

In another, either supplementary or alternative, embodiment the network accessible service display is rendered and/or managed via a dedicated software application. Such software application may, for example, be a mobile application or other client software. The application may communicate with a remote entity such as a remote server executing server-side software.

In a further, either supplementary or alternative, embodiment the arrangement is configured to obtain an indication of a location of a user via a client terminal device the user is applying for accessing the service display. A client terminal device may generally be a computer, mobile phone such as smartphone, tablet, phablet, or any other network accessible device the location of which may be at least coarsely tracked. The user location may be obtained through the monitoring of e.g. IP (Internet Protocol) address, when a user visits the service display such as web page over an IP network, preferably the Internet. Preferred geolocation software or e.g. network accessible service may be utilized to map the IP address to a (geo)location.

Alternatively or additionally, other techniques to obtain user location information may be utilized such as cellular positioning (e.g. based on Cell ID (CID)), Wi-Fi and/or satellite positioning methods, optionally the GPS.

In another, either supplementary or alternative, embodiment the arrangement is configured to obtain an indication of the user location via a second client terminal device instead of the first terminal device through which the user accesses the asset's service display. For example, a user may have registered his/her both terminal devices with the service so that they are both associated with the user. A user may ultimately have a plurality of position trackable terminal devices that the arrangement may, either one at a time or collectively, optionally even simultaneously, utilize to obtain the indication.

In a further, either supplementary or alternative, embodiment the arrangement is configured to define a number of geographical content provision zones, preferably by asset manager input or control input from other source(s), and store the data in a zone database. Alternatively or additionally, zone configuration may be at least partially automated by the arrangement entities. For example, an asset manager may determine the asset's physical location, whereafter the arrangement generates a number of zones related to the asset automatically based on a predefined, potentially adjustable, logic.

The defined geographical content provision zones are preferably at least two-dimensional. They may comprise or be represented as a number of geometrical objects such as circles, spheres or other circular, or generally circumferential, objects relative to an asset's physical location. Alternatively or additionally geographical content provision zones may be configured by other geographical or geography-linked constraints such as streets, landmarks, city borders, zip code areas etc., or via free-form map area selections on an electronic map layout view, for instance.

In a further embodiment the content provision zones are associated with one or more content items. Content item may be or incorporate an advertisement, offer, an indication of reservation situation or basically any other information relating to the asset and provided on the service display.

The content may comprise textual, visual and/or audible elements, e.g. texts, images and/or videos. The content may be provided as a banner or pop-up, for example. Alternatively or additionally, content provided to the user may contain an action trigger such as a redirection link to another web address, for example.

The content may be generated by asset manager input or other input, and be stored in the zone database. Alternatively or additionally, the arrangement may be configured to generate content automatically based on e.g. the location of the related asset and/or type of the asset (e.g. field of business).

In a further, either supplementary or alternative, embodiment the content provision zones and/or content items are configured to follow a time schedule.

Using a time schedule it may be defined when a content provision zone is active and thereby providing content to a user visiting a service display. Content provision zones may comprise multiple content items per zone. The playback of content items may be configured to follow the time schedule, whereupon the users may be provided with temporally-dependent, variable content. Alternatively or additionally, at least some content items may be provided to the user(s) randomly. The service display may be configured to set up a tracking means, e.g. cookies, to allow the provision of varying and e.g. personalized content to the user(s), and/or the monitoring of content usage or related actions.

In a further, either supplementary or alternative, embodiment the arrangement comprises a service control UI (User Interface) such as web page, configured to obtain e.g. asset manager input, such as general control input, location data, content data and/or schedule data to manage the data provision, typically marketing, campaigns provided via the service display, and e.g. related data acquisition or monitoring tasks.

In a further, either supplementary or alternative, embodiment the arrangement comprises one or more server entities, optionally in a cloud computing environment, configured to host at least part of the arrangement. In one embodiment, the arrangement may be considered or implemented as one unified server arrangement hosting all the constituting entities. Alternatively, e.g. the location management entity may be hosted by a separate entity, optionally a third party server or service, configured to communicate location data. Alternatively or additionally, the network accessible service display may be hosted by a separate server, optionally a third party entity, providing a web hosting service.

In a further, either supplementary or alternative, embodiment the arrangement is configured to determine user statistics regarding service display visits. The statistics may, preferably, indicate the number of visits, zone or generally location of visits and/or actions (e.g. ‘clicks’) taken by the users. Such information may then be provided to asset managers or other interested, qualified parties even in real time in the form of various reports or (web) dashboards showing desired metrics, for instance.

In another aspect, a method for location based content provision to be performed by an electronic arrangement, comprises
defining a number of geographically limited content provision zones, preferably by asset manager input, for an asset associated with a geographical location,
monitoring user visits to the asset's network accessible service display, preferably a web page regarding the asset,
obtaining an indication of a location of a visiting user,
providing content to said user visiting said network accessible service display based on the particular zone whereto the user is mapped in view of the location indication.

In one embodiment user statistics are obtained, regarding service display visits, preferably comprising number of visits, location of visits and/or actions taken by all or selected users. Statistics may be observed by asset managers or other concerned parties optionally in real time e.g. via a digital dashboard that may be web-accessible or requiring a specific client software for the access.

The method may be optionally collectively performed by a number of entities, such as a server arrangement comprising one or more servers providing the display and related location-based features. Yet, a terminal device such as a smartphone, tablet, laptop or desktop computer may be utilized by the user to access the service display.

The previously presented considerations concerning the various embodiments of the arrangement may be flexibly applied to the embodiments of the method mutatis mutandis and vice versa, as being appreciated by a skilled person.

The utility of the present invention follows from a plurality of issues depending on each particular embodiment. A web user's physical location may be cleverly and transparently utilized for providing targeted and thereby potentially particularly interesting information to the user, which may accompany more users to the location of the asset.

The arrangement may provide asset managers with a user friendly solution for both temporally and geographically targeted content provision. An asset manager may effortlessly create and manage multiple marketing campaigns, for instance, by defining geographical zones, content and a time schedule.

The arrangement may also monitor user statistics and report such information optionally in real time, which allows asset managers to even take immediate effect on the campaigns and hence, optimizing campaign implementation and evaluate its success via appropriate marketing performance measurement and management (MPM) methods.

Editing campaign data and parameters such as the actual content to be distributed via the service display and/or related rules (e.g. zones, scheduling, the appearance of content items, etc.) may be effectuated even during the campaign based on the reports or e.g. dashboard data, optionally different indicators and metrics responsive to user visits on the service display, provided by the arrangement optionally in real-time fashion.

The expression “a number of” refers herein to any positive integer starting from one (1), e.g. to one, two, or three.

The expression “a plurality of” refers herein to any positive integer starting from two (2), e.g. to two, three, or four.

Different embodiments of the present invention are disclosed in the dependent claims.

### BRIEF DESCRIPTION OF THE RELATED DRAWINGS

Next the invention is described in more detail with reference to the appended drawings in which

FIG. 1 illustrates the overall concept of the present invention via an embodiment thereof;

FIG. 2 illustrates an embodiment of an arrangement in accordance with the present invention;

FIG. 3 is a block diagram representing the internals of an embodiment of the arrangement with emphasis on the related hardware; and

FIG. 4 is a flow diagram disclosing an embodiment of a method in accordance with the present invention.

### DETAILED DESCRIPTION OF THE EMBODIMENTS

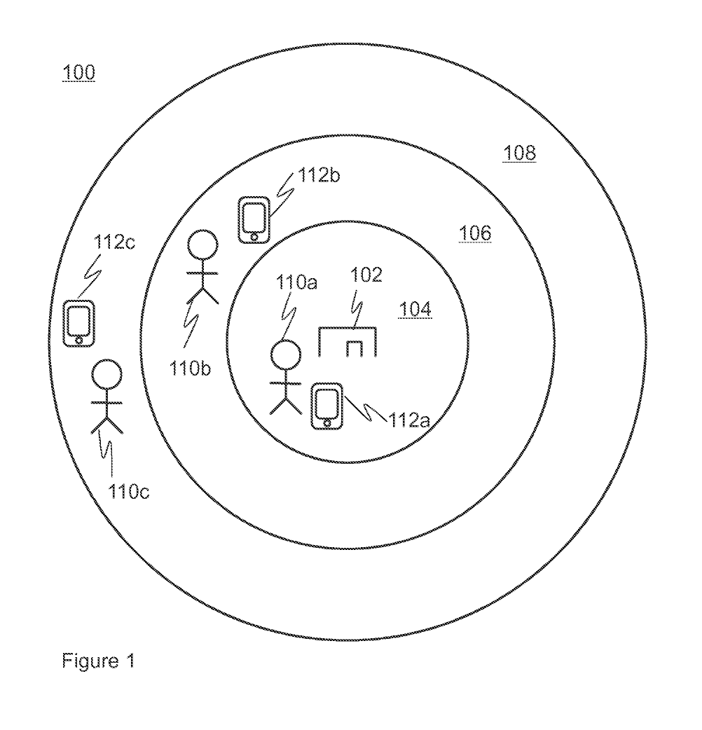

FIG. 1 illustrates, at 100, the overall concept of the present invention according to an embodiment thereof.

The arrangement may be configured to define and store multiple content provision zones 104, 106, 108 for targeted content provision. The content provision zones 104, 106, 108 are geographical areas relating to an asset's 102 physical location. The zones 104, 106, 108 are thus considered as meaningful from the standpoint of the asset 102, e.g. store, bar, or event, and its location. For instance, the asset's location may be surrounded and/or covered by one or more zones as depicted in the figure. Alternatively, the asset 102 could be at the border, or partly define the border, of one or more zones. Yet, the asset 102 could be adjacent or remote to one or more zones.

The zones may be geographically non-overlapping, e.g. concentric rings, or, there may be a number of zones, e.g. nested zones, with some common overlapping area(s).

An asset 102 may be any entity, resource, or item, e.g. business, with or at least associated with a physical location such as a store, event location (e.g. concert, sports event or basically almost any type of real-world gathering) or restaurant, which has an incentive to provide information to its users or customers.

Within the content provision zones, users 110a, 110b, 110c may be provided with targeted, digital content when visiting the asset-related, network accessible service display such as a web page. The content may incorporate an advertisement, offer, event and/or reservation update, for example.

The user may visit the asset's network accessible service display, optionally web page, with a terminal device 112a, 112b, 112c such as a mobile phone, laptop computer, desktop computer, tablet, phablet, or any other conventional computing device applicable to connect to a communications or specifically computer network, preferably using the World Wide Web (WWW), to access the service display. The arrangement may obtain an indication of the user's location based on positioning the terminal device 112a, 112b, 112c. Responsive to the related zone 104, 106, 108 the user is mapped to in view of the location, targeted content may be then provided to the user via the service display.

With reference to the scenario depicted in FIG. 1, three content provision zones 104, 106, 108 related to the physical location of the asset 102 have been defined by circles (of different radiuses) substantially centrically surrounding the location. As is understood, the location zones could be determined by other geometrical areas and shapes as well, such as squares, triangles or any other suitable designs.

The content provision zones may be optionally determined by geographical constraints such as streets, landmarks, city boarders, zip code areas, etc. The zones may be user defined by an asset manager, or the arrangement may provide automatically at least a suggestion for zones when an indication of the physical location of the asset is provided to the arrangement as coordinates or pointed on a digital map layout, for example.

The arrangement may comprise a control UI (User Interface), such as a service control web page, through which an asset manager may define the content provision zones. Circular zones may be defined by entering limiting/border radius values for each zone, for example. The interface may comprise a digital map layout, where the asset manager may draw respective content provision zones, optionally with a terminal device comprising a touch based UI, such as a smartphone or tablet device. Optionally, the location of the asset may be indicated via the map layout as alluded above.

Anyone managing an asset's information at or relative to the arrangement may be considered as an asset manager from the standpoint of the present invention. He/she may be an employee for the asset or a third party entity assigned to manage the asset's information with no other mandatory relation to the asset, for example. The asset manager could especially be a marketing manager or other member of the marketing personnel responsible for the digital visibility of the asset in the media.

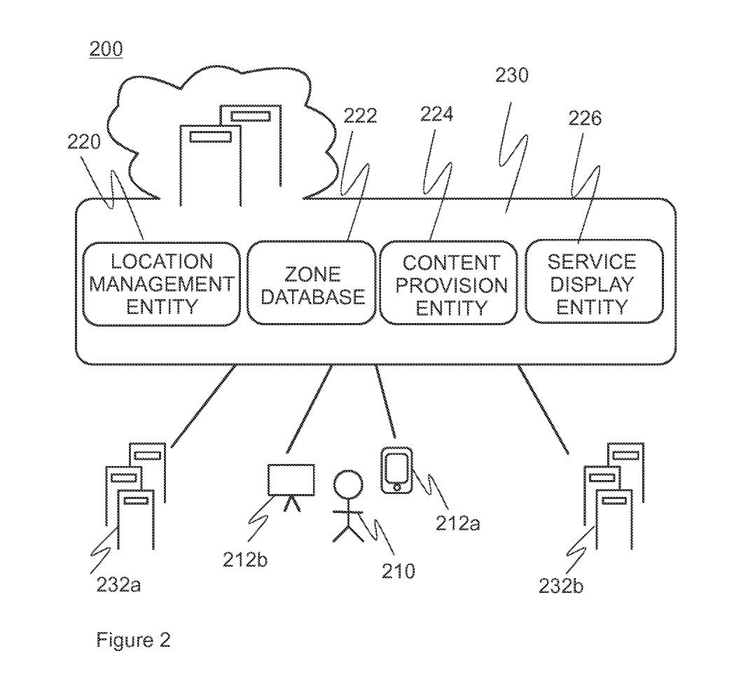

FIG. 2 illustrates, at 200, an embodiment of the arrangement with emphasis on the internal logic thereof. The arrangement 230 may, in some embodiments, comprise a number of or a plurality of server entities, preferably in a cloud environment, for hosting the shown entities.

A user 210 may utilize one or more client (terminal) devices 212a, 212b for accessing an asset's service display, such as a web page or related web site. Access may be realized by using a browser application at the terminal device 212a, 212b or e.g. dedicated client software.

Optionally, one of the devices 212b, e.g. desktop computer, may be used to access the service display whereas another device 212a, e.g. mobile terminal, may be utilized for obtaining an indication of the user location, for example. Optionally, said another device 212a may be polled for location data upon detecting service access by an identified user 210 or user terminal 212b.

The user 210 may have registered in the service (display) either directly or via more generic access control option such as selected single sign-on (SSO) property, e.g. Facebook Connect™ or Google ID™, and provided information thereto identifying and/or otherwise characterizing the user, his/her terminal device(s), etc. Accordingly, the service may be able to associate one user or user terminal with a number of terminals.

Indeed, the arrangement 230 may comprise a network accessible service display entity 226, preferably incorporating or at least partially controlling a display element such as a web page with at least visual and optionally audible content. As mentioned in multiple occasions hereinbefore, instead of a web page/web site the service display could be provided via a dedicated service accessed via (dedicated) client software application such as a proprietary computer application or specifically, a mobile application. Even if no standard browser UI was utilized, the communication between the client and the network entity/entities could exploit web-based technologies such as HTTP (Hypertext Transfer Protocol) or HTML (HyperText Markup Language).

A web page or other realization of the service display may be provided e.g. using HTML language. The display contain textual, visual and audible content. Different add-on such as Macromedia Flash™ or Javascript™ may be applied to render the display more vivid and dynamic. The display may be directly hosted by the suggested arrangement or by a number of other remote server entities 232a with which the service display entity 226 is functionally connected for control over the content. The service display may contain dynamic elements configured to communicate with the arrangement, or rest of the arrangement depending on the embodiment. The dynamic elements may allow changes in the content provision.

Another, at least logically identifiable, entity of the arrangement 230 is a location management entity 220 configured to obtain an indication of user location. Location indication may be obtained based on locating a user terminal, e.g. user terminal digital address such as IP (Internet Protocol) address, and/or by cellular, Wi-Fi or GPS positioning.

The indication may be at least partly determined externally, i.e. by element(s) residing outside the arrangement, optionally at a remote server entity 232b hosting e.g. geolocation service/providing location data. Additionally or alternatively, location data such as address data and/or GPS coordinates may be directly obtained from the associated user terminal devices 212a, 212b in response to a location data request, for instance.

The arrangement 230 comprises a zone database, or data repository, 222 to store data such as zone definitions and optionally related content data. The data may generally comprise geographical data, content items (graphics, text, video, audio, etc.), and scheduling data, for example. The data may be inputted or adapted by the asset manager and/or automatically by the arrangement logic. For instance, selected content distribution and scheduling algorithms may be utilized to generate a feasible location/content/time schedule data for asset campaigns. A skilled person will appreciate the fact that the term ‘database’ may herein refer to one or more databases of selected format(s) and/or other data repository/repositories capable of storing the necessary information regarding the zones.

Dedicated data including location/zone, content and/or time schedule data may be referred to as ‘campaign’ from a standpoint of an asset. Further follow-up data such as reports indicative of e.g. campaign penetration may be included. A number of selected algorithms may be used to monitor and control the arrangement and utilize asset manager input for generating at least partially ready-made contents, determine locations/zones, time schedules and/or a combination of these (campaign). Algorithms may for example, take into account the assets' field of practice such as restaurant, shop, theatre, ski center etc. and generate for each field generally suitable contents, locations/zones, time schedules and/or a combination of these.

The arrangement 230 may be configured to host/provide a service UI such as service control page as a part of or via the asset's own web page(s) or as a separate service web page, for example. Such service page may be configured to receive user input data regarding content provision e.g. from the asset managers or arrangement operators. The asset manage may provide information for controlling the targeted content provision. Such information may comprise geographical location information data indicative of zones, content data to be delivered to users residing in the zones, and/or related time schedule data affecting content selection and/or distribution, for example.

Additionally, the arrangement 230 comprises a content provision entity 224 configured to utilize the zone database 222 and provide a user visiting a service display from a detected physical location with targeted content (item(s)) in accordance with the zone information stored.

The content provision entity 224 may compare the obtained user location data with stored content data and based on the user's location and/or e.g. time of service display visit, the content provision entity 224 may select suitable content data item(s) from the zone database 222 and provide such to the user via the service display. Each content item may have been associated with one or more zones and/or suitable distribution or reproduction/playback time slots.

A web site/web page serving the users with the service display may for example comprise JavaScript™ or other dynamic means allowing the content provision entity to communicate with the web page and providing the user with targeted content.

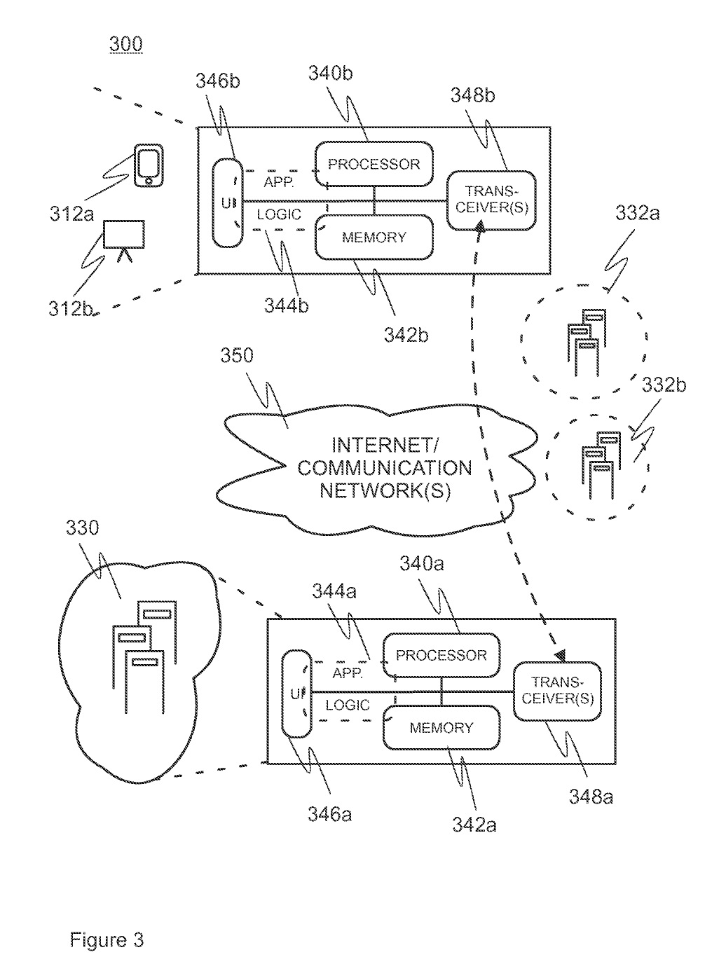

FIG. 3 illustrates, at 300, an embodiment of the presented invention with the emphasis on the related applicable hardware. The arrangement may comprise a number of server entities, preferably in a cloud environment allowing flexible and dynamic resource allocation among other benefits.

One or more server entities 330 of the arrangement may comprise a number of processor 340a and memory 342a devices. Processor devices 340a may contain elements such as microcontrollers, microprocessors, DSPs (digital signal processor), programmable logic chips, etc. for executing instructions and processing various data potentially stored in one or more memory elements 342a such as memory chips. Optionally, at least some processing and memory elements may be integrated.

The arrangement may also comprise a number of software application(s) 344a (computer program products) to execute the different tasks the arrangement is set to fulfill such as obtaining indication of user location, processing zone database and comparing stored content data with user location, providing content to service display, etc. Software may be stored in memory element(s) 342a for execution by processor element(s) 340a.

The UI 346a (User Interface) may refer to local and/or remote UI feature, allowing control of the server 330 hardware and/or the software 344a. Local UI may comprise data output means, such as a display, and/or input means such a mouse, keyboard or touch surface, for example.

Remote UI functionalities may be offered via a data transfer interface 348a. The data transfer interface, preferably a network interface such as Ethernet or other LAN (Local Area Network) interface, allows connecting to external network(s) 350, preferably the internet enabling communication with remote terminal devices 312a, 312b and e.g. external server arrangements 332a, 332b. Browser-based UIs with e.g. HTTP and HTML (HyperText Markup Language) may be provided, for example. A web server may be hosted for the purpose.

Entities 332a and 332b illustrate external elements that may communicate with the arrangement and provide data such as location data, host service displays (e.g. asset-related web sites), etc.

For example, location management entity may communicate with a number of server entities 332a for obtaining location information regarding the users accessing the service display via their terminal devices that can be positioned.

Additionally or alternatively, the service display may be hosted and operated by a number of server entities 332b, e.g. web servers, configured to communicate with the arrangement. The service display preferably supports dynamic elements for dynamic content provision e.g. from the zone database. The remote server entities 332a, 332b may generally comprise similar elements as the server arrangement 330.

As mentioned hereinbefore, in some embodiments the arrangement 330 may itself host/operate at least part of the service display and/or at least part of the positioning elements.

Also, the terminal devices 312a, 312b that are in possession of the users and used for accessing the service display, may generally comprise corresponding elements such as a number of processing entities 340b, memory entities 342b, data transfer interfaces 348b, e.g. a cellular and/or wired network (Ethernet or other LAN) interface, software application(s) 344b and UI 346b such as a touch surface, commonly and increasingly available in contemporary smartphones and tablets, or a keypad in laptop or desktops, for example.

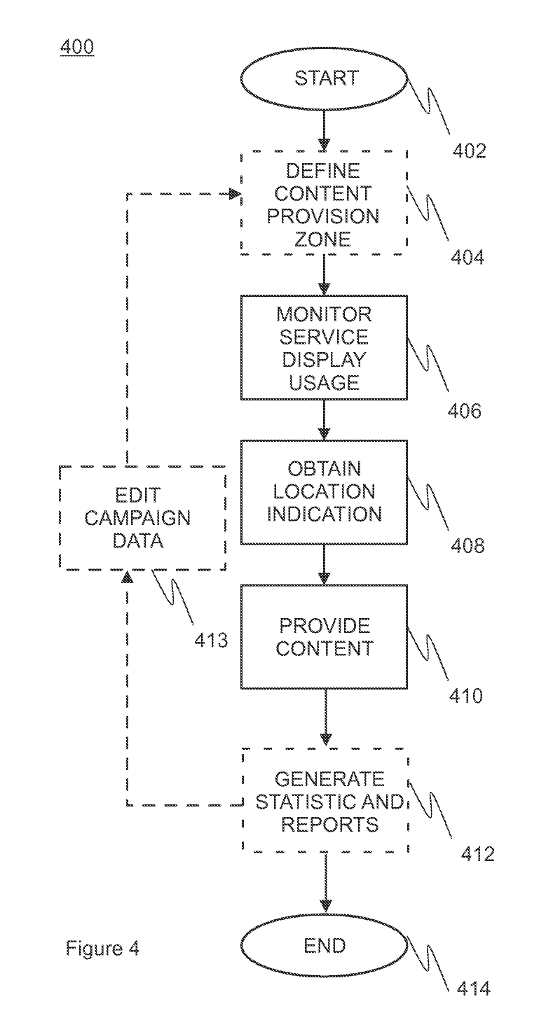

FIG. 4 includes, at 400, a flow diagram of an embodiment of the method according to the present invention for targeted provision of content to users visiting a network accessible service display, to be performed by an electronic arrangement, optionally a number of server entities. Method items associated with user presence or user actions are marked with solid lines in the figure, whereas other items for managing and controlling the shown activity are marked with dotted lines.

At 402, method start-up, preparatory actions may take place. This might comprise setting up a number of server entities and the needed software, adjusting the configurations, establishing necessary network connections, etc.

At 404, content provision data is configured. Content provision data may comprise geographical location data such as asset location and/or zone-defining data, content data and/or time schedule data. The data may be generated by asset manager input or at least partially automatically by the arrangement of the present invention.

The execution of the method may be considered as repetitive or continuous having regard to many method items, particularly 406, 408, 410, as multiple users visit the service page, their locations are determined, and targeted content provided accordingly.

However, after the zones and related content provision rules have been defined, the actual content such as ads obtained, and the service display ramped up, further execution of item 404 may be basically unnecessary until the definitions are edited, new content provided, old content removed, campaign scheduling of content distribution revised, etc., which is indicated by the dotted loop-back arrow and revision item 413. Accordingly, from the standpoint of ordinary service (end-) users, one may consider item 406 as the first step of the method execution they perceive.

Indeed, at 406 a user visits the service display via e.g. a browser application installed at a terminal device, such as a mobile terminal, laptop, or desktop computer, for instance, which is monitored and detected by the arrangement executing the method. The network accessible service display may correspondingly contain a web page associated with a target asset having a physical location such as a store, restaurant, event, etc.

At 408, an indication of user location is obtained. The location of the user accessing the service display, e.g. web page, with a terminal device, may be obtained by different (terminal) positioning means such as IP address, GPS, Wi-Fi and/or cellular network, e.g. cell-ID, based tracking.

At 410, suitable targeted content item(s) are determined based on the user location relative to the content provision zones. The arrangement preferably provides the content to the user via the visited service display.

Additionally or alternatively, targeted content item(s) could be provided via a supplementary channel or device. For instance, if the user visited the service display via a communications channel or terminal of a first type (e.g. desktop computer), the content could be provided via a communications channel or terminal of a second type (e.g. mobile terminal) provided that the service is capable of reaching the user via multiple technologies/devices.

As mentioned hereinbefore, the user may have registered or logged in the service, whereupon the service may, based on the available user profile or other available user data, determine the applicable technologies/devices for content provision.

At 412, the arrangement calculates or otherwise establishes statistics on e.g. user visits, user locations, clicks (i.e. content selections on the service display), and/or provided content items, and generates observable reports to target entities such as asset managers.

Statistics may be established and optionally observed substantially in real-time e.g. via a digital (web) dashboard during the execution of the method and/or aggregated as a final report at the end of the content provision period, which may imply the expiry of the content provision campaign relating to the particular asset in question.

At 414, method execution is ended, but as explained hereinearlier, the execution of the method items is typically repetitive and responsive to e.g. user visits on the service display. Campaign content and rules may be edited optionally several times during the campaign with reference to item 413.

A computer software product embodied in a non-transitory carrier, such as a memory card or an optical disc, may be provided to enable execution of the method items by a target computer device belonging to the arrangement, e.g. a server.

Generally, in various embodiments the asset manager may determine a content provision campaign by defining geographical location, zones, content information items to be distributed and/or related time schedules. An asset manager may define a number of geographical locations and zones for content provision.

An asset may be associated with one or more physical/geographical locations, potentially still a single location. However, e.g. chain stores or chain businesses in general may want to include multiple physical assets (e.g. store/bar/event locations) and related locations in a single campaign. Accordingly, zones relating to the assets, or asset locations, shall be defined either manually, in a computer-assisted manner (default zones may be determined and suggested, whereupon the asset manager may accept them as is or modify the suggestions), or fully automatically, e.g. based on different radiuses from the given asset location(s).

For example, a zone may be determined, as indicated in FIG. 1, by an area spanned by two concentric circles of different radiuses enclosing the location of the asset. In the shown case, the zones are additionally substantially asset location-centric. Alternatively or additionally, geographical location information may be configured by other geographical constraints such as streets, landmarks, city borders, zip code areas etc.

In some embodiments, a border line or border radius could be defined for a zone such that all areas outside the line/radius or inside the line/radius will belong to the zone. Optionally, two or more zones may be geographically overlapping, i.e. they have some common area. The asset does not have to be surrounded or covered by all or any of the zones. Instead, the asset may be adjacent or remote to one or more zones.

The asset manager may set time limits for the geographical determinations so that the content provision as controlled by the arrangement follows a desired time schedule.

As being associated with the indicated geographical locations and/or zones, content items are selectively provided to a user visiting the asset's service display.

Optionally, an asset manager may solely or mainly provide information regarding the asset's physical location and e.g. field of practice, whereupon the arrangement will generate a data provision, e.g. marketing, campaign structure matching with the field and location according to predefined logic. Obviously still, content items to be provided to the users based on their location upon service display access shall be obtained.

Next, different aspects of the method and arrangement in accordance with the present invention will be explained through three feasible, but essentially still only exemplary, use scenarios:

### Scenario 1:

First, a ski center desires to increase their sales and decides to set up a related data provision or marketing campaign. The marketing manager (i.e. asset manager) logs in the arrangement service page optionally through the ski center's (i.e. asset's) own web page. The manager may input the asset's physical location if not being already stored at the arrangement as associated with asset-related account.

Subsequently, the manager may define a plurality of campaign zones. As an example only, the manager defines three campaign zones (i.e. content provision zones), a first zone with a 5 km radius, a second zone with a 50 km radius and a third zone having a 100 km radius.

The arrangement may be then configured to generate the zones in a way that first zone area covers range 0-5 km, the second 5-50 km and the third 50-100 km, or the zones may be added on top of each other, so that the first area covers range 0-5 km, second 5-55 km and third 55-155 km, depending on the embodiment of the arrangement. The zones may have, but do not need to have, as a skilled person will readily understand, circular borders.

Next the manager may indicate the content to be provided. Content items may be user (manager)-provided or generated/selected automatically but preferably with user supervision or modification option.

The arrangement may then store a set of content items, such as at least partly textual items exhibiting messages ‘5% discount on ski tickets today’, ‘rent ski's for −30% tomorrow’ and ‘next weekend under 7 year olds get free entrance accompanied by a parent’, for example. These could be linked to the zones so that the first text would be provided to the users accessing the service display within the closest range, the second text to the users within the second closest range and the third text to the users within the third range, for example.

In other words, the linkage between content items and zones may have a temporal aspect. Zone closest to the asset(-related) location may be associated with content items that are temporally closest, etc.

Next, a manager may define a time schedule for these contents to be provided to user's visiting the service display, preferably web site. The manager may decide that they will be shown on a Tuesday 1 pm-3 pm. The arrangement may comprise options for daily, weekly or monthly repetition, for example

Now, when a user is within 5 km from the ski center on Tuesday between 12-15 and visits the asset's web page, the user will be provided with the content item indicating ‘5% discount on ski tickets today’. The item may be provided as a banner or pop-up via a web page, for example.

### Scenario 2:

A shop in Helsinki, decides to set up a campaign. The shop manager (i.e. asset manager) logs in the arrangement service web page and selects as a first area the city of Helsinki, as a second area the remaining capital area, which comprises a few cities around Helsinki, as third area the rest of Finland and as a fourth area outside of finish boarders (i.e. rest of the world).

The arrangement may store, as content items, different offers such as ‘5% discount on everything for the rest of the day’, ‘10% discount on everything tomorrow morning 9 am-10 am’ and ‘the fall selection will arrive next weekend, come and have a look’, ‘summer clearance sales in three weeks’ which could be associated with the content zones, first text to closest, second text to second closest, third text to third and fourth to fourth, for example.

The manager may further decide a time schedule for the contents and/or content zones. The first content zone may be valid for the first day between 12-15 pm, the second content for the first day between 12-21 pm, and the third for the rest of the week, whereas the fourth is valid for 3 weeks, for example. The manager may adapt the campaign whenever he/she likes and provide e.g. new content. The manager may also observe statistics regarding service display visits and/or receive a report after the campaign has completed with a statistics summary. Such reports may also be generated during the campaign, for example, daily, weekly or monthly to enable campaign revision while it is still ongoing.

### Scenario 3:

A theatre gets a two-person cancellation one hour before the show. The reservation service may be linked to the arrangement, providing everyone within 5 km of the theatre visiting the theatre's web page with a pop-up or other message ‘2 tickets available, click here for booking’ and the first user to activate the indicated functionality may then book the tickets, for example.

Further scenarios may be easily contemplated by a skilled person based on the above teachings. For instance, e.g. a browser or dedicated client software-based service display could be provided in connection with, or integrated with, messaging or chat service application, considering popular WhatsApp™ or Skype™ as examples. When a user resides in, enters, or leaves, a predefined zone at certain instant, he/she may be provided with a related, topical message via the display.

Consequently, a skilled person may on the basis of this disclosure and general knowledge apply the provided teachings in order to implement the scope of the present invention as defined by the appended claims in each particular use case with necessary modifications, deletions, and additions, if any.

1. An electronic arrangement comprising
a network accessible service display entity for enabling a user to obtain information regarding an asset associated with physical location via service display accessible with a terminal device,
a location management entity configured to obtain an indication of a physical location of the user,
a zone database configured to store a plurality of geographical content provision zones for the asset relating to the physical location of the asset, and
a content provision entity configured to provide content to a user visiting said service display based on the particular zone whereto the user location is mapped.

2. The arrangement of claim 1, wherein the service display incorporates a web site or web page at least partially controlled by the service display entity.

3. The arrangement of claim 1, configured to obtain control input regarding the existing content or content provision rules and to edit said content or content provision rules responsive to the control input.

4. The arrangement of claim 1, configured to obtain control input regarding the existing content or content provision rules and to edit said content or content provision rules responsive to the control input, wherein the arrangement is obtain said input during a data provision campaign relating to the asset and to revise said content or rules during the campaign based on the input to preferably take effect substantially immediately.

5. The arrangement of claim 1, wherein a geographical content provision zone or a content item is associated with temporal data, optionally a time schedule, period of validity, expiration period, or expiration time.

6. The arrangement of claim 1, configured to associate a geographical content provision zone physically closer to the location of the asset with a content item temporally closer to the present, and configured to associate another geographical content provision zone farther away from the location of the asset with another content item temporally farther from the present.

7. The arrangement of claim 1, wherein the location management entity is configured to obtain the indication of the location of the user via the terminal device of the user.

8. The arrangement of claim 1, configured to obtain the indication of the location of the user via the terminal device's IP (Internet Protocol) address.

9. The arrangement of claim 1, configured to obtain the indication of the location of the user via cellular data, optionally cell-ID data, associated with the terminal device.

10. The arrangement of claim 1, configured to obtain the indication of the location of the user via positioning data, optionally GPS (Global Positioning System) or GLONASS (Global Navigation Satellite System) data, associated with the terminal device.

11. The arrangement of claim 1, configured to obtain the indication of the location of the user via a second terminal device, wherein the second terminal device has been linked with the user in the user information accessible to the arrangement.

12. The arrangement of claim 1, configured to transmit data to construct said service display via a dedicated software application, optionally a mobile application, running on the terminal device.

13. The arrangement of claim 1, configured to define one or more geographical content provision zones by manual control input, optionally through selection via graphical user interface preferably incorporating a map layout.

14. The arrangement of claim 1, wherein at least one geographical content provision zone encompasses, surrounds or neighbors the physical location of the asset.

15. The arrangement of claim 1, wherein one or more of said geographical content provision zones are substantially of regular shape, optionally substantially of circular, elliptical, or square shape.

16. The arrangement of claim 1, wherein a geographical content provision zone is at least partially defined by a geographical separator, optionally street, river, bridge, railway, sea, shore, building, park, forest or other landmark.

17. The arrangement of claim 1, wherein a geographical content provision zone is at least partially defined by administrative border, optionally city, district or other area border.

18. The arrangement of claim 1, wherein a geographical content provision zone is associated with a plurality of optionally dedicated content items, such as at least partially visual items incorporating textual and optionally audible message elements.

19. The arrangement of claim 1, comprising one or more server entities, optionally located in a cloud computing environment, configured to host the entities and the zone database.

20. The arrangement of claim 1, configured to determine statistics or metrics, optionally accessible via a digital dashboard, regarding service display visits, preferably comprising indication of the number of visits, location of visiting users and/or actions taken by user via the service display.

21. The arrangement of claim 1, wherein the asset is at least one element selected from the group consisting of: a business, restaurant, club, cafeteria, store, department store, warehouse store, chain of stores, boutique, beauty salon, hear salon, cobbler, rental service, hotel, gas station, sports venue, institution, governmental institution, and event.

22. A method for location based content provision to be performed by one or more electronic devices, comprising
defining a number of geographically limited content provision zones for an asset associated with a geographical location,
monitoring user visits to the asset's network accessible service display, preferably a web page regarding the asset,
obtaining an indication of a location of a visiting user, and
providing content to said user visiting said service display based on the particular zone where the user location is mapped to.

23. The method of claim 22, wherein statistics are determined regarding service display visits, preferably comprising information on the number of visits, locations of visiting users and/or actions taken by the users.

24. A computer program product embodied in a non-transitory computer readable carrier medium, comprising computer code causing the computer to execute:
defining one or more geographical content provision zones for an asset associated with a geographical location,
monitoring visits to the asset's network accessible service display, optionally a web page regarding the asset,
obtaining indication of a location of a user visiting the service display, and
providing digital content to said user based on the particular zone where the user location is mapped to.
